(19) United States
(12) Patent Application Publication
(10) Pub. No.: US 2008/0032728 A1
(43) Pub. Date: Feb. 7, 2008

(54) SYSTEMS, METHODS AND DEVICES FOR COMMUNICATING AMONG MULTIPLE USERS

(76) Inventors: Bina Patel, Franklin Park, NJ (US); Neal C. Foster, Manalapan, NJ (US); Majid Syed, Hershey, PA (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/462,130

(22) Filed: Aug. 3, 2006

(51) Int. Cl. H04B 7/00; H04Q 7/20

(52) U.S. Cl. 455/518

(57) ABSTRACT

An embodiment relates generally to a method of communicating among multiple users. The method includes establishing a first push-to-talk over cellular (“POC”) connection between a first terminal device having a client port and a second terminal device. The first terminal device then receives a second POC connection attempt notification at the client port from a third terminal device. The method also includes selecting one of: (1) establishing a second POC connection with the third terminal device at the client port; or (2) putting the second terminal device on hold at the client port of the first terminal device.

### FIELD

This invention relates generally to systems, methods, and devices for communication among multiple users, more particularly, managing multiple push-to-talk cellular connections on a mobile terminal.

### DESCRIPTION OF THE RELATED ART

Push-to talk (“PTT”) is a two-way communication method that uses a half-duplex mode where transmission occurs in both directions, but not at the same time. A user typically presses a button on a PTT device while speaking, and then releases it when done talking. The listener must then do the same to respond.

Push-to-talk Over Cellular (POC) is a PTT voice service for mobile communications. POC provides a direct one-to-one and one-to-many voice communication service in a cellular (mobile) network. It is based on half-duplex Voice-over-Internet Protocol (“VoIP”) technology that allows a PTT service to use cellular access resources. POC service is available over many cellular networks. The IDEN™ network offered by Nextel and Push-to-Talk by Cingular are examples of existing POC systems.

In a typical POC system, a dedicated channel, sometimes referred to as a broadcast channel, is used to transmit communications from one member to one or multiple other members simultaneously. Generally, only one member may transmit voice information to the other member users at any given time. If another member attempts to transmit over the broadcast channel while another member is transmitting, interference between the two competing communications will occur, resulting in nonintelligible communications being received by the other members.

Session Initiation Protocol (“SIP”) is used to set up and tear down a POC connection in many systems. SIP is a protocol developed by the Internet Engineering Task Force (“IETF”) MMUSIC working group and is further described in RFCs 2543 and 3261 (see, for example, http://www.rfc-archive.org/), which are hereby incorporated by reference. The POC system then typically uses Real-time Transport Protocol (“RTP”) to transport voice packets between SIP clients, i.e., mobile terminals. RTP defines a standardized packet format for delivering audio and video over the Internet. This standard was developed by the Audio-Visual Transport Working Group of the IETF and first published in 1996 as RFC 1889, which is hereby incorporated by reference.

Open Mobile Alliance (“OMA”) is a mobile industry working group that is designed to be a center for mobile service specification work and for stimulating and contributing to the creation of interoperable services (see, e.g., http://www.openmobilealliance.org/). The OMA has promulgated an OMA POC Control Plane specification (OMA-TS-POC ControlPlane V1_{—}0-20050428-C) which describes an implementation for call waiting functionality, which is hereby incorporated by reference in its entirety. The implementation of this function requires an optional feature, called multiple sessions at both the clients and server of a POC system. This means that call waiting functionality is limited to POC systems where the POC server supports multiple sessions. Accordingly, the implementation of OMA POC call waiting functionality in existing systems may require expensive modifications to the infrastructure of existing POC systems.

### SUMMARY

An embodiment relates generally to a method of communicating among multiple users. The method includes establishing a first push-to-talk over cellular (“POC”) connection between a first terminal device having a client port and a second terminal device and receiving a second POC connection attempt notification at the client port of the first terminal device from a third terminal device. The method also includes either: (1) establishing a second POC connection with the third terminal device at the client port of the first terminal device; or (2) and putting the third terminal device on hold to connect with the second terminal device at the client port of the first terminal device.

Another embodiment pertains generally to a terminal device for communicating with multiple parties. The terminal device includes a cellular interface configured to receive and transmit cellular communications, where the cellular interface is also adapted to interface with a push-to-talk (PTT) server. The terminal device also includes a user interface configured to receive commands and voice packets for the terminal device and POC client configured to manage a plurality of POC connections over a client port. The POC client is also configured to establish a first POC connection between the terminal device and a second terminal device through the client port and to receive a second POC connection attempt notification at the terminal device from a third terminal device. The POC client is further configured to select either: (1) establishing a second POC connection with the third terminal device at the client port of the first terminal device; or (2) maintaining the first POC connection with the second terminal device.

Yet another embodiment relates generally to a system for communicating among multiple users. The system includes a cellular network and a plurality of terminal devices. Each terminal device is configured to establish multiple push-to-talk over cellular (“POC”) channels over the cellular network with each other. Each terminal device includes a POC client configured to establish a first POC channel with a second terminal device at a local port and to place the first POC channel in a hold status in response to connecting with a second POC channel with a third terminal device at the local port.

Accordingly, embodiments generally assist users in managing multiple connections among multiple users. More particularly, a POC client provides a mechanism on a mobile terminal to connect and manage more than one session connection with multiple users. Unlike conventional POC systems which require the PTT server to manage the multiple connections, the POC client manages the connection over an existing cellular network. Thus, there is a substantial cost savings to implement POC call waiting with the POC client because of the lack of required changes to PTT servers.

### BRIEF DESCRIPTION OF THE DRAWINGS

Various features of the embodiments can be more fully appreciated, as they become better understood with reference to the following detailed description of the embodiments when considered in connection with the accompanying figures, in which:

FIG. 1 illustrates an exemplary terminal device in accordance with an embodiment;

FIG. 2 illustrates an exemplary system for the terminal device in accordance with another embodiment;

FIG. 3 illustrates an exemplary connection diagram for a PTT server and three mobile terminals in accordance with yet another embodiment;

FIG. 4 illustrates an exemplary call flow diagram for registration of a terminal device with the system shown in FIG. 2 in accordance with yet another embodiment;

FIG. 5 illustrates an exemplary call flow diagram for a POC connection between two terminal devices in accordance with yet another embodiment;

FIG. 6 illustrates an exemplary call flow diagram for multiple POC connections between multiple terminal devices in accordance with yet another embodiment;

FIG. 7 illustrates an exemplary flow diagram for establishing a POC connection in accordance with yet another embodiment; and

FIGS. 8A-B, collectively, illustrate an exemplary flow diagram for managing multiple POC connections by the POC client in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of mobile communication systems, and that any such variations do not depart from the true spirit and scope of the present invention. Moreover, in the following detailed description, references are made to the accompanying figures, which illustrate specific embodiments. Electrical, mechanical, logical, and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to a method, system, and/or apparatus for a client-based implementation of push-to-talk cellular (“POC”) call waiting. More particularly, a mobile terminal executing a client may implement POC call waiting functionality to communicate with and manage multiple POC sessions with various parties. Unlike conventional systems that use a server to implement POC call waiting functionality among multiple sessions, a client at the mobile terminal may be configured to manage the multiple sessions. This client-centric POC call waiting may provide a mechanism to implement POC call waiting without expensive upgrades to the infrastructure of existing mobile systems.

For example, in some embodiments, a first mobile terminal may be connected to a second mobile terminal over a first POC connection. A third mobile terminal may request to connect to the first mobile terminal using a second POC connection. The first mobile terminal refuses the request to connect with the third mobile terminal and continues its session with the second terminal device,

In other embodiments, a first mobile terminal may be connected to a second mobile terminal over a first POC connection. A third mobile terminal may request to connect to the first mobile terminal using a second POC connection. The first mobile terminal may place the second mobile terminal in a hold status and switch to the third mobile terminal in response to the request from the third mobile terminal. Subsequently, the first mobile device may switch between the second and third mobile terminals until the session ends with either one of the second and third mobile terminals.

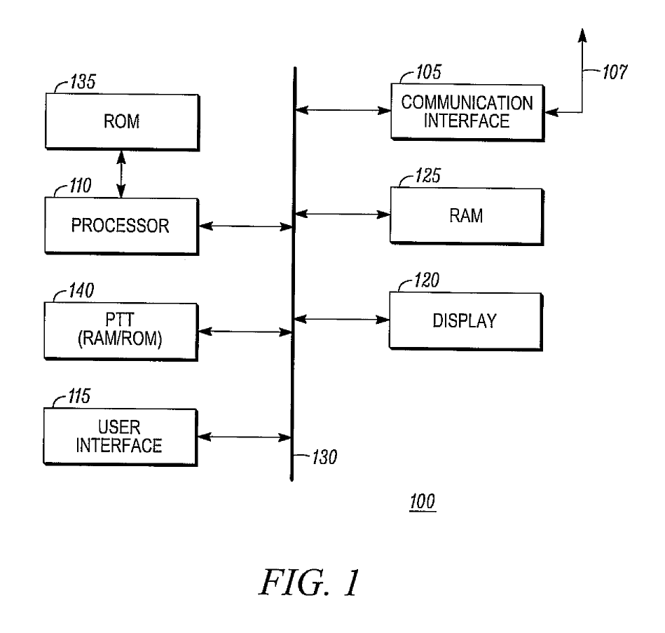

FIG. 1 illustrates an exemplary embodiment of a mobile terminal 100 in accordance with an embodiment. It should be readily apparent to those of ordinary skill in the art that the mobile terminal 100 depicted in FIG. 1 represents a generalized schematic illustration and that other components may be added or existing components may be removed or modified. Moreover, the mobile terminal 100 may be implemented using software components, hardware components, or combinations thereof.

As shown in FIG. 1, the mobile terminal (or mobile client) 100 includes a communication interface 105, a processor 110, a user interface 115, a display module 120, and storage 125. If the communication interface 105 is wireless, it is configured to facilitate communication over an air interface with a base station of a cellular network that supports POC such as the iDen™ network. More particularly, the communication interface 105 may transmit and receive digital voice packets through a radio frequency (RF) antenna 107. The communication interface 105 is configured to interface with a shared bus 130. Voice packets to be transmitted may be forwarded from the user interface 115 to the communication interface 105 over the shared bus 130 as well as received voice packets forwarded to the user interface 115 over the shared bus 130.

The processor 110 is configured to interface with the shared bus 130. The processor 110 implements the software that embodies the functionality of the mobile terminal 100, which may be stored in processor memory 135 (labeled as ROM in FIG. 1). The ROM 135 may also or alternately be programmable read only memory, flash memory, or a similar type of high speed persistent storage. The processor 110 may be an application specific integrated circuit, programmable field gate array, a microprocessor, digital signal processor, or similar type of computing platform.

Storage 125 (labeled as ROM in FIG. 1) may be configured to store information for a user of the mobile terminal 100. For example, a contact list, music files, and/or digital images may be stored in storage 125. The storage 125 may be implemented using a persistent storage such as flash memory. In some embodiments, the storage function of the processor memory 135 may be provided by storage 125.

In this embodiment, user interface 115 is configured to interface with the shared bus 130. The user interface 115 facilitates interaction with a user. As such, the user interface 115 may include media input and output mechanisms. For example, to facilitate voice communications, these mechanisms may include a microphone (not shown) for receiving analog speech signals from a user and a speaker (not shown) for playing out analog speech signals to a user. Further, the mobile terminal 100 may include digital/analog media signals and digital representations of those signals, for example, a soft button on a keyless display.

The user interface 115 may also include a keypad (not shown). The keypad may be a Bell keypad, a QWERTY keyboard, or similar mechanisms. In some embodiments, the keypad may be emulated on the display 120. The user interface 115 may further include a mechanism or device to initiate POC functionality. For example, the mechanism may be a POC button (not shown) or other mechanism that a user can readily engage in order to initiate a PTT function.

In accordance with various embodiments, the processor 110 is configured to execute a POC client 140. The POC client 140 may be a computer program embodiment of functionality for client-based POC call waiting. More particularly, the POC client 140 may be configured to manage multiple POC sessions. The POC client 140 may have established a first POC connection with a second POC client in a second mobile terminal. A POC client of a third mobile terminal may request to connect to the POC client 140 of the first mobile terminal using a second POC connection. The POC client 140 may place the first POC connection in a hold state and switch to the third mobile terminal in response to the request from the third mobile terminal. Subsequently, the POC client 140 may switch between the first and second POC connections under the control of the user utilizing the user interface 115. Alternatively, the POC client 140 may refuse the connection with the third POC client and continue with the conversation over the first POC connection.

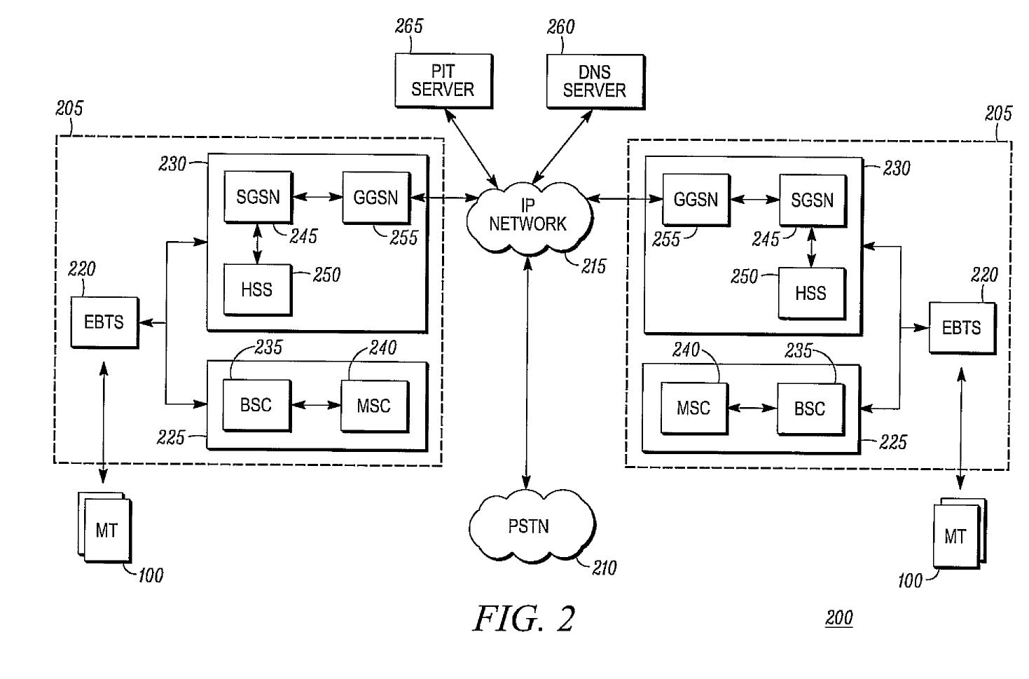

FIG. 2 illustrates an exemplary system 200 in accordance with another embodiment. It should be readily apparent to those of ordinary skill in the art that the system 200 depicted in FIG. 2 represents a generalized schematic illustration and that other components may be added or existing components may be removed or modified. Moreover, the system 200 may be implemented using software components, hardware components, or combinations thereof. In this embodiment, the system 200 includes at least one mobile terminal 100 such as shown in FIG. 1.

As shown in FIG. 2, the system 200 includes access cells 205. The access cells 205 interface with an Internet Protocol (“IP”) network 215. The IP network 215 may be the internet, a private local area network, a private wide area network, or combinations thereof. The IP network 215 may also interface with the public switched telephone network 210 (labeled as PSTN in FIG. 2).

Each access cell 205 includes an enhanced base transceiver station 220 (labeled as “EBTS”). The EBTS 220 is configured to transmit and receive voice packets from mobile terminals 100 within the coverage area of the EBTS 220. The EBTS 220 may also include a service integration module (not shown) that is configured to determine the current state of each mobile terminal in the coverage area of the EBTS 220.

The EBTS 220 interfaces with an interconnect call module 225 and a POC call module 230. The interconnect call module 225 includes a base site controller (labeled as BSC) 235 coupled with a mobile switching center (labeled as MSC) 240 for handling cellular and circuit switched calls. The MSC 240 may also be interfaced with a home location and visitor location registers (not shown) for providing mobility management as known in the art. The BSC 235 can provide control and concentration functions for one or more EBTS sites and their associated mobile terminals 100.

The POC call module 230 also includes a Serving GPRS Support Node (labeled as SGSN) 245 interfaced with a home subscriber server (“HSS”) 250 for processing POC calls and packet data. The HSS 250 may also be interfaced with home location and visitor location registers (not shown) for providing mobility management as known in the art. The HSS 250 may also be referred to as visitor location register or home location register. In the case of packet data, the SGSN 245 can route such packet data via a GPRS Gateway Support Node (labeled as GGSN) 255 to the IP network 215. The

The system 200 may further include a domain name server (labeled DNS) 260 and a PTT server 265. The DNS 230 is configured to provide DNS services as known to those skilled in the art. The PTT server 265 is configured to provide the call establishment services for POC calls between the mobile terminals 100. More particularly, for example, a first mobile terminal may initiate a POC call to a second mobile terminal. As part of the call setup, the PTT server 265 may receive the source internet protocol (“IP”) address and ports of the first mobile terminal, The PTT server 265 creates an IP address and ports to route the POC call as well as determines the destination IP address and port of the second mobile terminal.

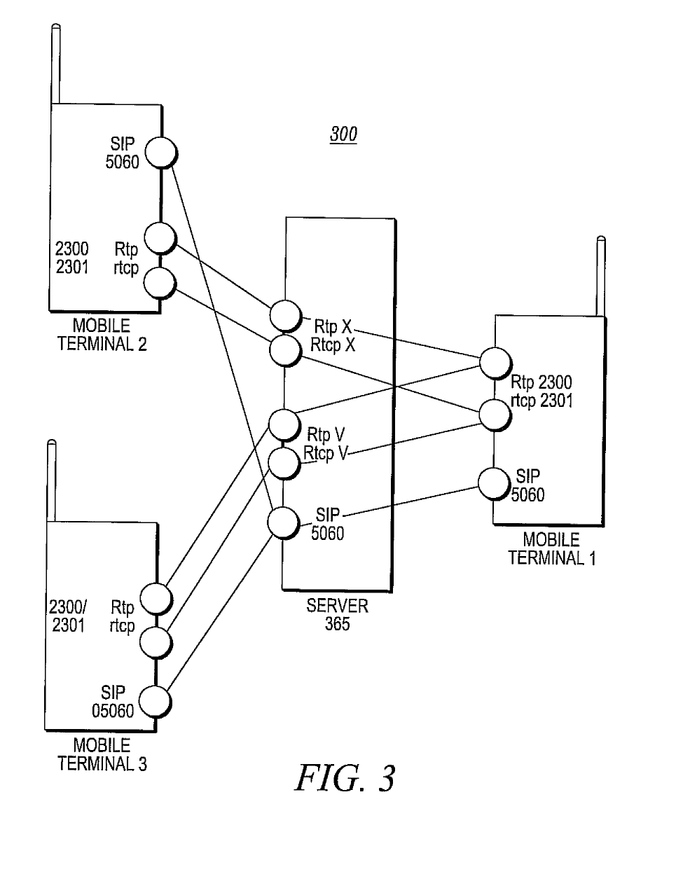

The system 200 may be configured to provide for a client-implemented call waiting functionality without the cost incurred of putting OMA call waiting functions in the PTT servers. More particularly, the POC client 140 of a first mobile terminal may connect to second mobile terminal using a first POC connection. A third mobile terminal may attempt to connect with first mobile terminal. The POC client of the first mobile terminal may connect with the third mobile terminal using a second POC connection while placing the first POC connection on hold. More specifically, the POC client 140 may transmit a Hold message to the second mobile terminal while accepting the call from the third mobile terminal. At this point, the POC client 140 is managing two POC connections from two different mobile terminals, which is schematically illustrated in FIG. 3.

FIG. 3 illustrates an exemplary connection diagram 300 for three mobile terminals in accordance with yet another embodiment. As shown in FIG. 3, mobile terminal 1 (“MT1”) represents a first of three mobile terminals; mobile terminal 2 (“MT2”) represents a second of three mobile terminals; and mobile terminal 3 (“MT3”) represents a third of three mobile terminals. Each of the mobile terminals has an RTP 2300 port, an RTCP 2301 port, and a Session Initiation Protocol (“SIP”) 5060 port.

When a POC call is formed between two of the mobile terminals, respective formatted data packets are transmitted through their associated ports, e.g., RTP packets are transported through the RTP ports. For example, mobile terminal 1 (“MT1”) and mobile terminal 2 (“MT2”) have formed a session to conduct their POC call. The PTT server 365 forwards the connection request from MT3 to MT1 to the same port of MT1 that is being used by the first POC call.

Accordingly, unlike conventional mobile terminals, the POC client 140 of MT1 is configured to process the connection attempt at the same port. More specifically, the POC client 140 of MT1 accepts or declines the connection attempt from MT3. If the user accepts the POC call from MT3, the POC client 140 of MT1 transmits a Hold message to the MT2 and connects with the second POC call from MT3.

The POC client 140 of MT1 may switch between the connection with MT2 and the connection with MT3. Continuing with the above example, if the user of MT1 switches from the MT3 connection to the MT2 connection, the POC client 140 of the MT1 issues a Hold message to MT3 to place MT3 on hold. The POC client 140 may subsequently or substantially simultaneously transmit an Activation message to the MT2 to reactivate the POC call with the MT2. The switching of POC sessions may continue by issuing the appropriate Hold and Activation messages to the respective parties until the end of both POC calls.

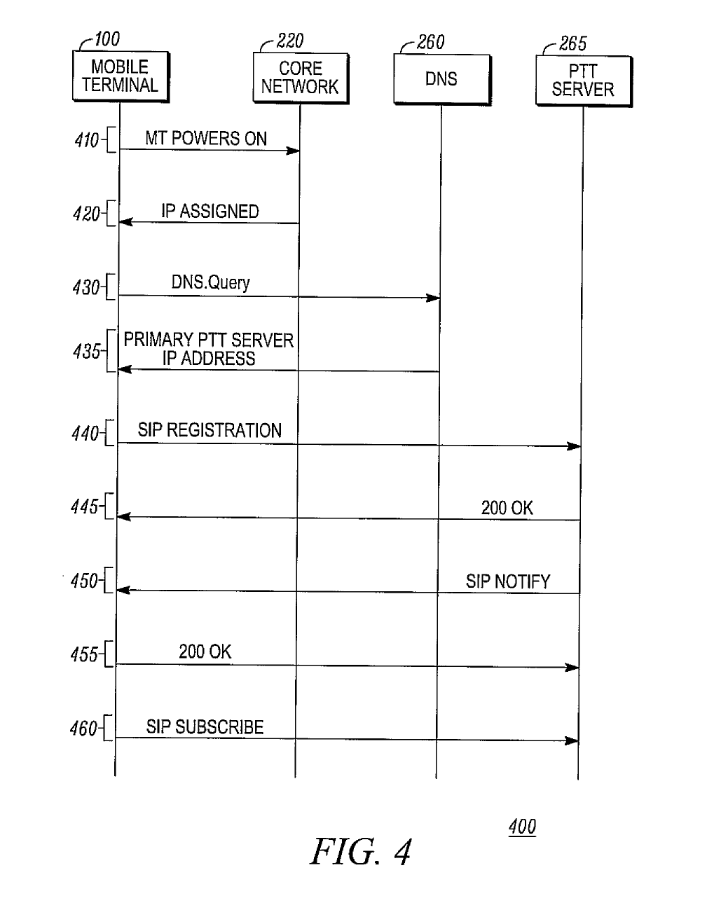

FIG. 4 illustrates an exemplary call flow diagram 400 for when the mobile terminal 100 powers on in an access cell 205 (shown in FIG. 2). It should be readily apparent to those of ordinary skill in the art that the call flow diagram 400 depicted in FIG. 4 represents a generalized illustration and that other flows may be added or existing flows may be removed or modified.

As shown in FIG. 4, a mobile terminal 100 may be powered on in sequence 410. The mobile terminal 100 handshakes with EBTS 230 to exchange information for call management within the EBTS 230. As part of the handshake process, an IP address is assigned to the mobile terminal 100 from the POC application processor 250, in sequence 420.

In sequence 430, the mobile terminal 100 transmits a BIND Query to the DNS server 260 requesting the location of a PTT server, e.g., PTT server 265 shown in FIG. 2. The DNS server 260 returns the IP address of the PTT server assigned to the mobile terminal 100. A UT-115 provides a mechanism to enter the IP address of the PTT server, e.g., PTT server 265, that manages the POC calls for the mobile terminal, in sequence 435.

In sequence 440, the mobile terminal 100 requests a Session Initiation Protocol (“SIP”) registration with the assigned PTT server. Information such as the IMSI, IP address of the mobile terminal 100, the Real Time Protocol (“RTP”) port, RTP packet format, etc. may be forwarded to the PTT server 265.

In sequence 445, the PTT server 265 returns an acknowledgement of a successful SIP registration with a 200 OK message and also identifies its listen ports. The PTT server 265 may also transmit information such as a mobile directory number, a buddy list version, and other similar information to the mobile terminal.

In sequence 450, the PTT server 265 transmits a SIP notify message to the mobile terminal 100. Included in the SIP notify message may be information such as group information, who in the group is online, etc. In sequence 445, the mobile terminal 100 acknowledges the SIP notify message with an acknowledgement message, 200 OK.

In sequence 460, the mobile terminal 100 transmits an SIP Subscribe message to the PTT server 265. The information in this message may include update group lists, protocol versions, mobile directory number, and other information known to those skilled in the art.

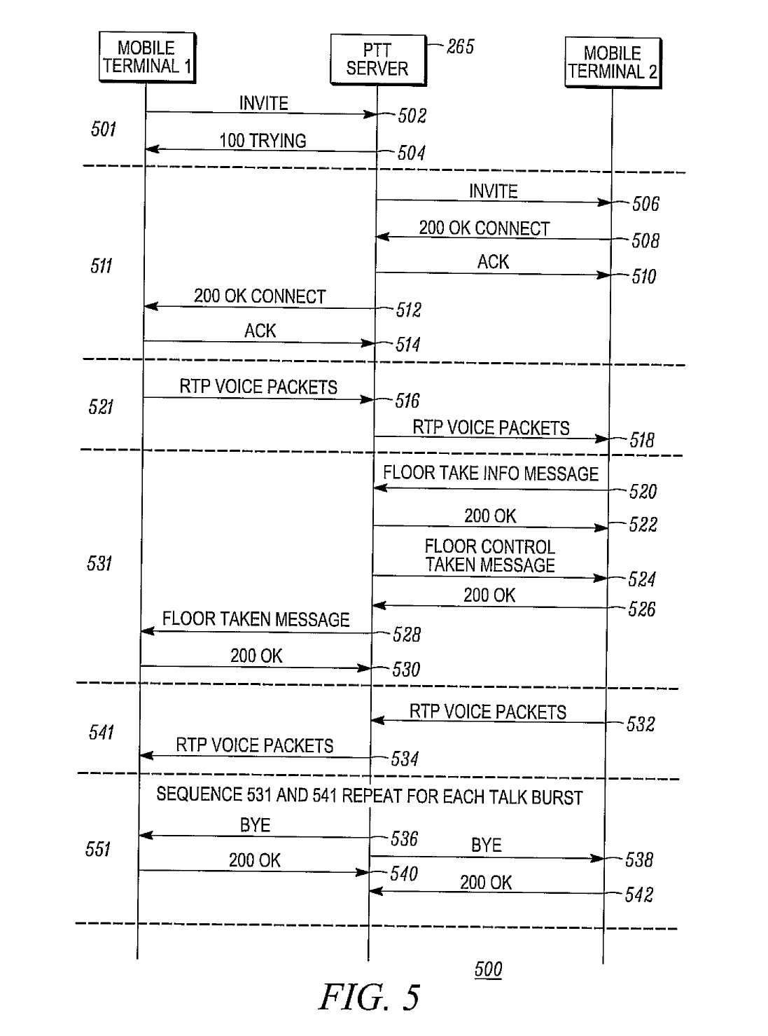

FIG. 5 illustrates an exemplary call flow diagram 500 for a POC call between two mobile terminals 100, It should be readily apparent to those of ordinary skill in the art that the call flow diagram 500 depicted in FIG. 5 represents a generalized illustration and that other flows may be added or existing flows may be removed or modified.

For illustration purposes, it is assumed that two mobile terminals 100 have been registered in their respective access cells 205. Accordingly, mobile terminal 1 (“MT1”) refers to one of the two mobile terminals 100 and mobile terminal 2 (“MT2”) refers to the second of the two mobile terminals 100.

As shown in FIG. 5, in sequence 501, the MT1 may initiate a POC call to MT2 by pressing a PTT button on the user interface. The POC client 140 of MT1 transmits an Invite message to the PTT server 265, in step 502. The Invite message may include identification of the MT2. The PTT server 265 may transmit a 100 Trying message (as an acknowledgement), i.e., an attempt-to-connect message, to the POC client 140 of MT1, which indicates that the PTT server 265 is trying to connect with MT2, in step 504.

As part of sequence 511, the PTT server 265 transmits an Invite message to the MT2, in step 506. This Invite message informs the POC client of the MT2 that MT1 is requesting for a POC call. If the user of MT2 accepts the Invite message, the POC client of the MT2 transmits a 200 OK connect message to the PTT server 265, in step 508. The PTT server 265 then transmits an acknowledgement message to the MT2, in step 510. The PTT server 265 may be configured to send a 200 OK connect message to the MT1 in response to the acknowledgement message from MT2, in step 512. The MT1 responds with an acknowledgement message to the PTT server 265, in step 514.

As part of sequence 521, the MT1 transmits the voice message of its user to MT2. As the voice message is being inputted into the user interface 115, the POC client 140 may be converting the analog voice signals into RTP formatted data packets, which are transmitted to the PTT server 265, in step 516. The PTT server 265 forwards the received RTP voice packets to the MT2, in step 518. Subsequently, the user of MT1 releases the PTT button of the user interface 115. Floor grant and floor taken tones are presented to the user through the user interface 115.

Accordingly, in sequence 531, the user of MT2 may depress the PTT button of the MT2 in response to the received voice message from the MT1. In step 520, the POC client of the MT2 may transmit a Floor-Take-Info-Message, which informs the PTT server 265 that the MT2 is going to take control of the POC connection. (The POC channel is a half-duplex channel where only one user may speak at a time). In step 522, the PTT server 265 sends a 200 OK message that indicates the MT2 has the control, i.e., the “floor.” Subsequently, the PTT server 265 may transmit a Floor-Control-Taken Message to the MT2, in step 524 and receive a 200 OK message, in step 526, from the MT2 in response to the Floor-at-Control-Taken Message. The PTT server 265 may also, substantially simultaneously, transmit the Floor-Control Taken Message to MT1, in step 528, to inform the POC client that MT2 has control of the POC connection. MT1 responds with a 200 OK message in step 530.

Accordingly, in sequence 541, the user at MT2 transmits is voice message in RTP formatted data packets to the PTT server 265, in step 532, and then to MT1 from the PTT server, in step 534. Sequence 531 and 541 repeat for each talk burst.

In sequence 551, the users of MT1 and MT2 conclude their conversation and disconnect. Accordingly, the PTT server 265 issues a BYE message to MT1, in step 536, while substantially simultaneously or soon after, the PTT server 265 issues a BYE message to MT2, in step 538. The BYE message indicates to the respective POC clients that the session is being broken down. The MT1 responds with a 200 OK Message acknowledging the dissolution of the session, in step 540. Similarly, MT2 may respond with the 200 OK Message, in step 542. Moreover, MT1 and MT2 may initiate a BYE message to end the call.

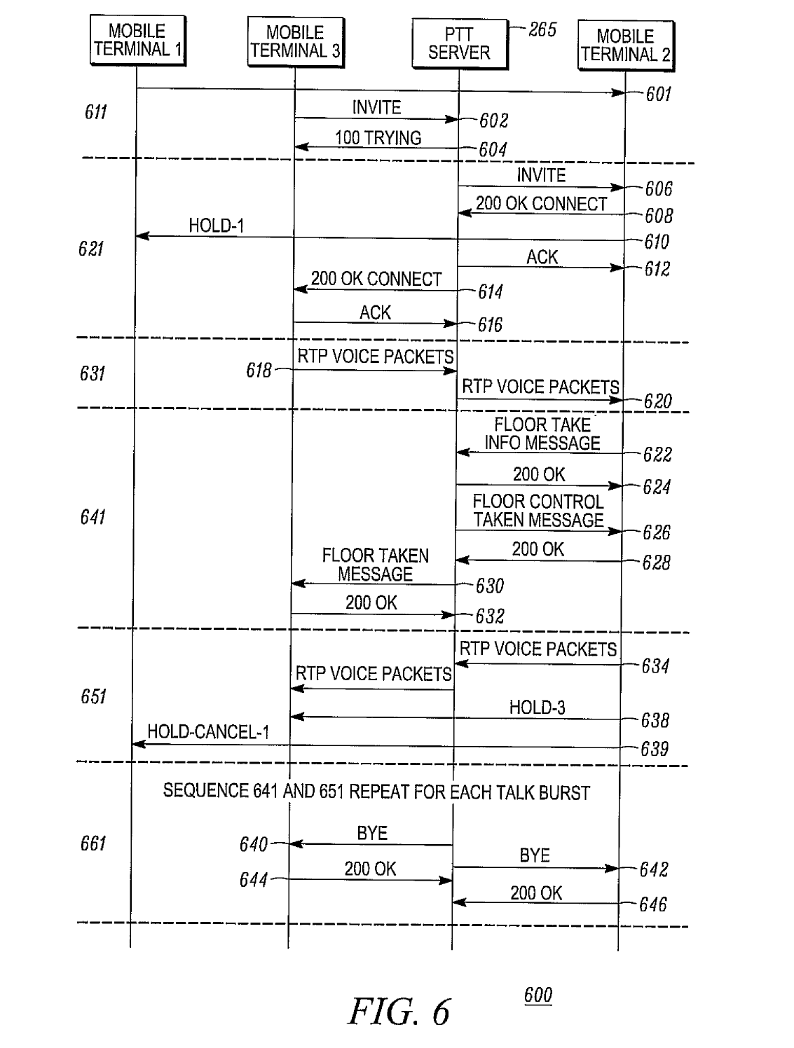

FIG. 6 illustrates an exemplary call flow diagram 600 for POC call waiting between three mobile terminals 100. It should be readily apparent to those of ordinary skill in the art that the call flow diagram 600 depicted in FIG. 6 represents a generalized illustration and that other flows may be added or existing flows may be removed or modified.

For illustration purposes, it is assumed that three mobile terminals 100 have been registered in their respective access cells 205. Accordingly, mobile terminal 1 (“MT1”) refers to one of the three mobile terminals 100, mobile terminal 2 (“MT2”) refers to the second of the three mobile terminals 100; and mobile terminal 3 (“MT3”) refers to the third of the three mobile terminals 100,

As shown in FIG. 6, sequence 611 may be predicated on MT1 and MT2 engaging in a POC call 601, as depicted in FIG. 5. In step 602, the POC client of MT3 is invoked to attempt a POC call to MT2. More particularly, a user of MT3 presses the PTT button on the user interface in attempt to contact MT2. The POC client of MT3 transmits an Invite message to its assigned PTT server, e.g., PTT server 265. The Invite message may be configured to inform the PTT server 265 that MT3 is attempting to connect with MT2 for a POC call. Subsequently, the PTT server 265 responds with a 100 Trying message to the POC client of MT3, in step 604, which indicates that the PTT server is attempting to connect with MT 2.

During sequence 621, the PTT server 265 transmits an Invite message to the POC client of MT2, in step 606. The POC client of MT2 may display a message to its user that the user of MT3 is attempting to call in. If user of MT2 elects to accept the call from MT3, the POC client of MT3 transmits a 200 OK Connect message to the PTT server 265, in step 608. The 200 OK Connect message indicates to the PTT server 265 that MT2 will accept the call from MT3. Subsequently, or substantially simultaneously, the POC client of MT2 issues a Hold message to the POC client of MT1, in step 610. The Hold message indicates to the POC client of MT1 that MT1 is being placed in a hold status.

Continuing on with sequence 621, the PTT server 265 responds to the 200 OK Connect message with an acknowledgement message in step 612. Subsequently, or substantially simultaneously, the PTT server 265 transmits a 200 OK Connect message to the POC client of MT3, in step 614. The POC client of MT3 responds to the 200 OK Connect message with an Acknowledgement message to the PTT server 265, in step 616.

As part of sequence 631, MT3 transmits the voice message of its user to MT2. As the voice message is being entered into the user interface 115, the POC client of MT3 may be converting the analog voice signals into RTP formatted data packets, which are transmitted to the PTT server 265, in step 618. The PTT server 265 forwards the received RTP voice packets to the MT2, in step 620. Subsequently, the user of MT3 releases the PTT button of the user interface 115.

During sequence 641, the user of MT2 depresses the respective PTT button in response to the received voice message from the MT1. In step 622, the POC client of the MT2 transmits a Floor-Take-Info-Message, which informs the PTT server 265 that the MT2 is going to take control of the POC connection In step 624, the PTT server 265 respond with a 200 OK message that indicates the MT2 has the control, i.e., the “floor.” Subsequently, the PTT server 265 transmits a Floor-Control-Taken Message to the MT2, in step 626, and receives a 200 OK message, in step 628, from the MT2 in response to the Floor-at-Control-Taken Message. The PTT server 265 may also, subsequently or substantially simultaneously, transmit a Floor-Control Taken Message to MT3 to inform the POC client that MT2 has control of the POC connection, in step 630. The POC client of MT3 responds with a 200 OK Message to the PTT server 265, in step 632.

During Sequence 651, MT2 transmits the voice message of the user to MT3. As the voice message is being entered into the user interface 115, the POC client of MT2 may be converting the analog voice signals into RTP formatted data packets, which are transmitted to the PTT server 265, in step 634. The PTT server 265 is configured to forward the received RTP voice packets to the MT3, in step 636. Subsequently, the user of MT2 releases the PTT Button to stop sending media to MT3. The user of MT3 may then select to activate the first connection with MT1 by selecting MT1 on the user interface 115 and pressing the PTT Button. Subsequently, or substantially simultaneously, in step 638, the POC client of MT2 issues a Hold message to the POC client of MT3 to place the POC client of MT3 in a Hold status. In step 639, the POC client of MT2 issues a HOLD-CANCEL message to the POC client of MT1 to place the POC client of MT1 in an Active status.

During sequence 661, the users of MT2 and MT3 conclude their conversation and disconnect. Accordingly, the PTT server 265 issues a BYE message to MT3, in step 640, while substantially simultaneously or soon after, the PTT server 265 may issue a BYE message to MT2, in step 642. The BYE message indicates to the POC clients that the PTT server 265 is tearing down the session. The MT3 may respond with a 200 OK Message acknowledging the dissolution of the session, in step 644. Similarly, MT2 may respond with the 200 OK Message, in step 646. Although not shown, MT2 and MT1 may continue with their conversation by using the steps depicted in Sequence 531 and 541 shown in FIG. 5.

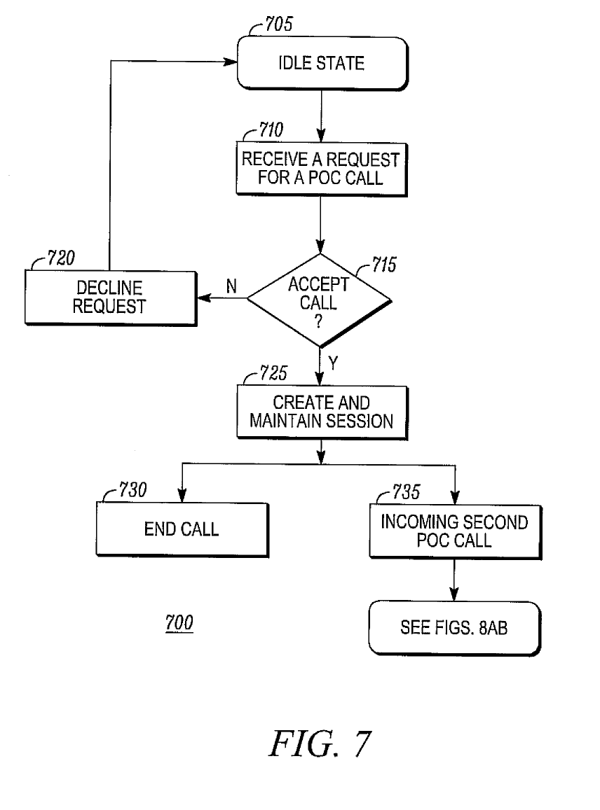

FIG. 7 illustrates an exemplary flow diagram for a POC client executing on a MT 100 in accordance with another embodiment. It should be readily apparent to those of ordinary skill in the art that the flow diagram 700 depicted in FIG. 7 represents a generalized schematic illustration and that other steps may be added or existing steps may be removed or modified.

As shown in FIG. 7, a POC client, e.g., POC client 140, is configured to be in an idle state, in step 705. During the idle state 705, a mobile terminal 100 may be powered on and the POC client 140 executing on the processor 110. In this example, the mobile terminal with the POC client 140 shows will be referred to as the second mobile terminal to maintain consistency with the call flow diagrams shown in FIGS. 4-6.

In step 710, the POC client 140 receives a request for a POC call from a first mobile terminal. In step 715, the user of the second mobile terminal 100 may elect to accept or decline the POC call. If the user elects to decline the incoming POC call, the POC client issues a Decline message to the PTT server 265, in step 720.

Otherwise, if the user elects to accept the incoming POC call, the POC client issues a 200 OK Connect message to the PTT server 265, as previously described in sequence 511, step 508 shown in FIG. 5.

Subsequently, the POC client 140 may maintain and manage the POC call as a session, in step 725. More particularly, the POC client 140 may execute the appropriate call flow steps associated with sequences 531 and 541 shown in FIG. 5.

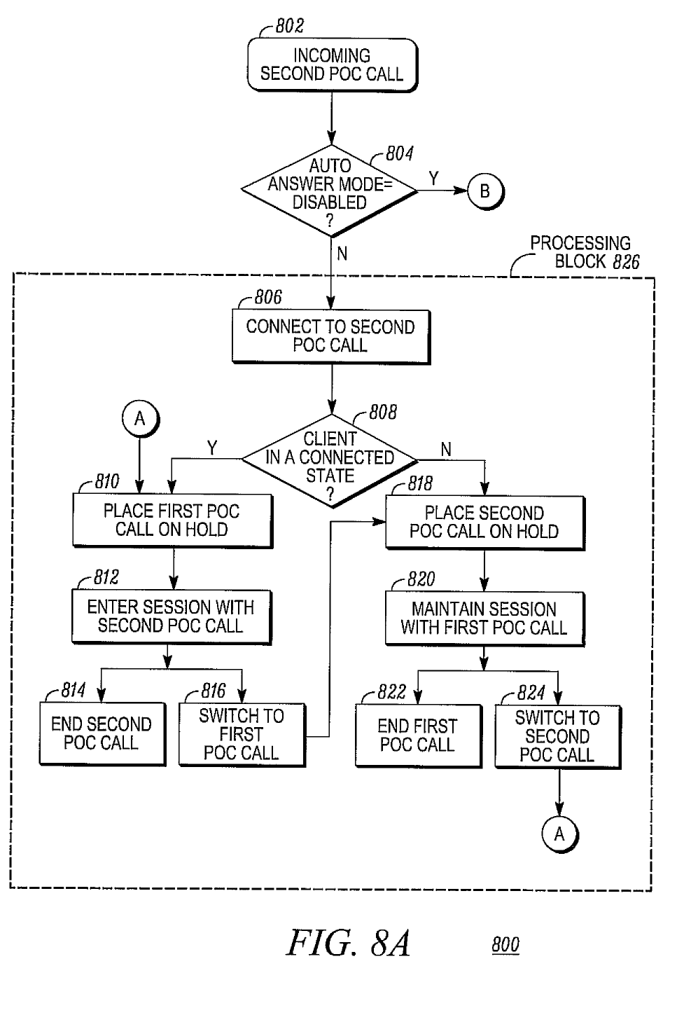

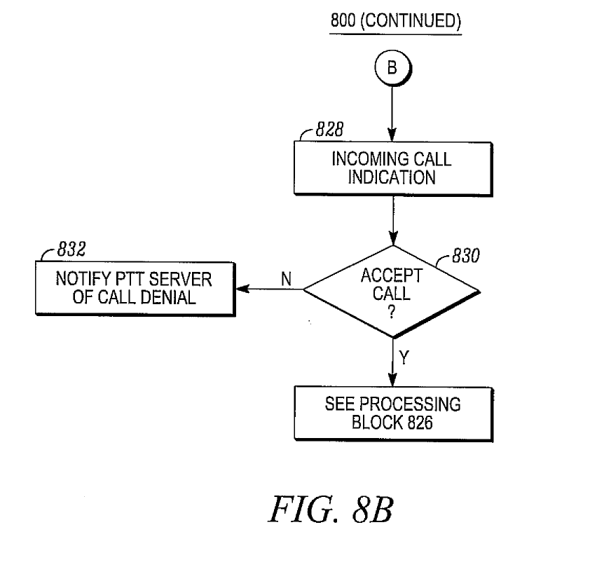

During the POC session, at least two events may occur to interrupt the session. In step 730, one of the mobile terminals may have elected to terminate the POC call. Accordingly, the POC client 140 may follow the steps in sequence 551 depicted in FIG. 5 and described earlier. Alternatively, in step 735, the POC client 140 may receive an indication of a second POC call from a third mobile terminal 100. The processing for the second incoming call is discussed in greater detail below with respect to FIGS. 8A-B.

FIGS. 8A-B, collectively, depict an exemplary flow diagram for a POC client executing on a second mobile terminal 100 processing a second POC call in accordance with another embodiment. It should be readily apparent to those of ordinary skill in the art that the flow diagram 800 depicted in FIGS. 8A-B represents a generalized schematic illustration and that other steps may be added or existing steps may be removed or modified.

As shown in FIG. 8A, the POC client 140 executing on a second mobile terminal 100 may receive an indication of another POC call, in step 802, while engaged in a first POC call with a first mobile terminal. More particularly, the PTT server 265 may have transmitted an Invite message from a third mobile terminal device as illustrated in FIG. 6 at sequence 621, step 606.

In step 804, the POC client 140 may determine whether an auto-answer mode has been enabled. More particularly, the auto-answer mode may be a mode of operation where the POC client automatically answers a second POC call. Accordingly, if the POC client 140 determines that auto-answer mode is disabled, the POC client proceeds with the processing of step 828 shown in FIG. 8B.

Returning to FIG. 8A, if the auto-answer mode is enabled, the POC client 140 connects to the third terminal device via a second POC call in step 806. If step 808 determines that the POC client 140 is in a connected stated with the first terminal device, step 810 places the first POC call on hold. In step 812, the POC client 140 enters and maintains the second POC call as a session. More particularly, the POC client 140 may execute the appropriate steps as previously described with sequences 641 and 651 in FIG. 6 as described previously.

During the POC session, at least two events may occur to interrupt the session. In step 814, one of the mobile terminals may have elected to terminate the POC call. Accordingly, the POC client 140 may follow the steps in sequence 661 depicted in FIG. 6 and described earlier to terminate the second POC call. Alternatively, in step 816, the POC client 140 may receive an indication to switch to the first POC call while maintaining the second POC call. More specifically, a user may use the user interface to switch to the first POC call.

When the user has initiated the switch to the first POC call, the POC client 140 places the second POC call on hold, in step 818, More particularly, the POC client 140 may transmit a Hold message in RTCP App Message format to the third mobile terminal.

In step 820, the POC client 140 is configured to maintain the session with the first POC call. More particularly, the POC client 140 may execute the steps of sequences 531 and 541 of FIG. 5 for the duration of the POC call.

For this POC session, at least two events may occur to interrupt the session. In step 822, one of the first or second mobile terminals may have elected to terminate the POC call. Accordingly, the POC client 140 may follow the steps in sequence 551 depicted in FIG. 5 and described earlier to terminate the call. Alternatively, in step 824, the POC client 140 may receive an indication to switch to the second POC call. Subsequently, the POC client 140 proceeds to the processing of step 810.

Turning to FIG. 8B, in step 828, the POC client 140 executing on a second mobile terminal 100 may receive an indication of another POC call while engaged in a first POC call with a first mobile terminal. More particularly, the PTT server 265 may have transmitted an Invite message from a third terminal device as illustrated in FIG. 6 at sequence 621, step 606.

In step 830, the POC client 140 may determine whether to accept the second POC call. More specifically, the POC client 140 may invoke a message regarding the second incoming call to be displayed on the display 120 for the user. If the user declines to accept the call, the POC client 140 transmits a Refusal message to the new incoming MT3 call (i.e., MT1-MT2 desire an uninterrupted session). Alternatively, if the user accepts the second POC call, the POC client 140 proceeds to processing block 826 depicted in FIG. 5A.

Certain embodiments may be performed as a computer program. The computer program may exist in a variety of forms both active and inactive. For example, the computer program can exist as software program(s) comprised of program instructions in source code, object code, executable code, or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via wired or wireless download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of communicating among multiple users, the method comprising;
establishing a first push-to-talk over cellular (“POC”) connection between a first terminal device having a client port and a second terminal device;
receiving a second POC connection attempt notification at the client port of the first terminal device from a third terminal device; and
performing one of establishing a second POC connection with the third terminal device at the client port of the first terminal device and putting on hold the first POC connection at the client port of the first terminal device in accordance with a user instruction.

2. The method of claim 1, further comprising placing the second terminal device on a hold status in response to the selection of establishing the second POC connection at the client port of the first terminal device.

3. The method of claim 2, further comprising transmitting a hold notification in RTCP App Message format to the second terminal device.

4. The method of claim 1, further comprising:
receiving an instruction to reconnect with the second terminal device;
placing the third terminal device in a hold status; and
reconnecting with the second terminal device over the first POC connection.

5. The method of claim 4, wherein the reconnecting further comprises transmitting an activate notification in RTCP App Message format to the second terminal device.

6. The method of claim 4, wherein placing the third terminal device in a hold status further comprises transmitting a hold notification in RTCP App Message format to the third terminal device.

7. The method of claim 1, wherein establishing a first POC connection comprises:
establishing the first POC connection through a push-to-talk (PTT) server with the second terminal device having a first destination internet protocol address.

8. The method of claim 7, further comprising:
establishing the second POC connection through the PTT server with the third terminal device having a second destination IP address.

9. A terminal device for communicating with multiple parties, the terminal device comprising:
a communication interface configured to receive and transmit wireless communications, wherein the communication interface is also adapted to interface with a push-to-talk (PTT) server;
a user interface configured to receive commands and voice packets for the terminal device; and
a push-to-talk over cellular (POC) client configured to manage a plurality of POC connections over a client port, wherein the POC client is also configured to establish a first POC connection between the terminal device and a second terminal device through the client port, receive a second POC connection attempt notification at the client port from a third terminal device, and to perform one of establishing a second POC connection with the third terminal device at the client port and maintaining the first POC connection with the second terminal device.

10. The device of claim 9, wherein the POC client is further configured to place the second terminal device in a hold status in response to establishing the second POC connection with the third terminal device.

11. The device of claim 10, wherein the POC client is further configured to transmit a hold notification in RTCP App Message format to the second terminal device.

12. The device of claim 11, wherein the POC client is further configured to to place the third terminal device in a hold status and reconnect with the second terminal device over the first POC connection.

13. The device of claim 12, wherein the POC client is further configured to transmit an activate notification in RTCP App Message format to the second terminal device to reconnect with the second terminal device.

14. The device of claim 13, wherein the POC client is further configured to transmit a hold notification in RTCP App Message formatto the third terminal device to place the third terminal in the hold status.

15. The device of claim 9, wherein the POC client is further configured to establish the POC connection through the PTT server and the second terminal device has a first destination internet protocol address.

16. The device of claim 15, wherein the POC client is further configured to establish the second POC connection through the PTT server and the third terminal device has a second destination IP address.

17. A system for communicating among multiple users, the system comprising:
a cellular network; and
a plurality of terminal devices, each terminal device configured to establish multiple push-to-talk over cellular (POC) connections over the cellular network with each other; wherein each terminal device further comprises a POC client configured to establish a first POC connection with a second terminal device at a local port and to place the first POC connection in a hold status in response to make a second POC connection with a third terminal device at the local port.

18. The system of claim 17, wherein the POC client is further configured to establish the POC connection through a push-to-talk (PTT) server with the second terminal device having a first destination internet protocol address and to establish the second POC connection through the PTT server with the third mobile terminal device having a second destination IP address.
